(19) United States
(12) Patent Application Publication
(10) Pub. No.: US 2008/0287151 A1
(43) Pub. Date: Nov. 20, 2008

(54) APPARATUS AND METHOD FOR COMMUNICATING WITH AN ASSET MONITORING DEVICE VIA TEXT MESSAGE

(75) Inventors: Kyle Fjelstad, Trabucco Canyon, CA (US); Sri Valarino, Laguna Hills, CA (US)

Correspondence Address: LUEDEKA, NEELY & GRAHAM, P.C., P O BOX 1871, KNOXVILLE, TN, 37901, US

(73) Assignee: PROCON, INC., Knoxville, TN (US)

(21) Appl. No.: 12/121,341

(22) Filed: May 15, 2008

Related U.S. Application Data
(60) Provisional application No. 60/938,081, filed on May 15, 2007.

(51) Int. Cl. H04Q 7/20

(52) U.S. Cl. 455/466

(57) ABSTRACT

A system enables communications between a mobile wireless communication device, such as a cellular phone, and an asset monitoring device using a text messaging protocol, such as Short Message Service (SMS). A command text message is entered on the mobile wireless device including a serial number of the asset monitoring device, a PIN and a command for the monitoring device. The command text message is transmitted via a wireless communication network and is forwarded to a service provider. Upon validation of the serial number and PIN, the service provider transmits a command to the wireless asset monitoring device via the wireless communication network. The wireless asset monitoring device receives the command and performs an action based thereon. For example, if the command is a LOCATE command, the wireless monitoring device transmits its current location, such as in latitude/longitude coordinates. The wireless asset monitoring device also transmits a response indicating a completed action or indicating that action was not taken for some reason. The service provider receives the response from the monitoring unit, parses the response, and constructs a report text message which is transmitted to the user's mobile communication device. The report text message is then displayed on the mobile communication device.

This application claims priority to co-pending provisional patent application Ser. No. 60/938,081 titled APPARATUS AND METHOD FOR DETERMINING POSITION OF TRACKING DEVICE VIA TEXT MESSAGE filed May 15, 2007, the entire contents of which are incorporated herein by reference.

### FIELD

This invention relates to the field of wireless communication, monitoring and tracking devices. More particularly, this invention relates to a system for communicating with a wireless asset monitoring device using text messages, such as may be transmitted from a wireless communication device using the Short Message Service (SMS) communication protocol.

### BACKGROUND

Short Message Service (SMS) is a telecommunications protocol that provides for communicating with “short” text messages (160 characters or less). It is generally available on most digital mobile phones and some personal digital assistants having onboard wireless telecommunication circuitry. The individual messages sent using the SMS protocol are typically referred to as text messages. Various SMS gateways exist to connect mobile SMS services with instant message (IM) services, the Internet, desktop computers, and landline telephones. The most common application of SMS text messaging services is person-to-person messaging. However, text messages have also been used to interact with automated systems, such as for ordering products and services for mobile phones and participating in contests.

Wireless asset monitoring devices have been developed which may be attached to a mobile asset, such as an automobile, to allow a user to determine the location of the asset and control certain functions of the asset. These devices typically obtain position information using global positioning system (GPS) satellite signals and transmit the position information using wireless digital cellular communication technology. One such system, wherein a user may access a web page via the Internet to track an asset, is described in U.S. Pat. No. 7,102,510, the entire contents of which are incorporated herein by reference.

There are times when a person may wish to determine the location of an asset or otherwise control functions of the asset when the person has no immediate access to a browser application for browsing the Internet. However, the person may have access to a wireless communication device, such as a cellular phone.

What is needed, therefore, is a system which would allow the determination of the location of a mobile asset and the control of certain functions of the mobile asset using a mobile wireless communication device, such as via SMS text messaging.

### SUMMARY

The above and other needs are met by a system for enabling communications between a mobile wireless communication device, such as a cellular phone, and a wireless asset monitoring device using a text messaging protocol, such as Short Message Service (SMS). In a preferred embodiment of the invention, a user of the mobile communication device enters a command text message which includes a serial number of the wireless asset monitoring device, a PIN or password assigned to the user, and a command for the wireless asset monitoring device. The command text message is transmitted from the mobile communication device to a wireless communication network, such as a cellular telephone network. The command text message is then forwarded to a service provider. Upon validation of the serial number and the PIN/password, the service provider transmits a command to the wireless asset monitoring device via the wireless communication network.

The wireless asset monitoring device receives the command and performs an action based on the command. For example, if the command is a LOCATE command, the wireless asset monitoring device transmits its current location, such as in latitude/longitude coordinates. If the command is a DISABLE STARTER command, the wireless asset monitoring device disables the engine starter of the vehicle in which it is installed. If the command is an ENABLE STARTER command, the wireless asset monitoring device enables the engine starter of the vehicle in which it is installed. If the command is an UNLOCK command, the wireless asset monitoring device unlocks the doors of the vehicle in which it is installed. In some embodiments, the wireless asset monitoring device also transmits a response indicating that the action was completed or indicating that the action was not taken for some reason.

The service provider receives the response from the wireless asset monitoring unit, parses the response, and constructs a report text message which is transmitted via the wireless communication network to the user's mobile communication device. The report text message is then displayed on the mobile communication device as a text message.

In one preferred embodiment, a method is provided for communicating information between a portable wireless communication device and a wireless asset monitoring device. The method includes steps of:
transmitting a command text message from the wireless communication device, wherein the command text message includes at least identification information that identifies the wireless asset monitoring device and function information that indicates one or more functions to be performed by the wireless asset monitoring device;
communicating at least the identification information and the function information via one or more communication networks to a service provider computer system associated with a service provider;
transmitting a command from the service provider computer system, the command including at least the identification information and the function information;
receiving the command at the wireless asset monitoring device identified by the identification information; and
executing the one or more functions at the wireless asset monitoring device as indicated by the function information.

In some embodiments, the following additional steps are provided in the method:
transmitting a response from the wireless asset monitoring device, wherein the response includes at least identification information for identifying the wireless asset monitoring device which transmitted the response and result information for indicating a result of the function executed by the wireless asset monitoring device;
receiving the response at the service provider computer system and extracting the identification information and the result information;
generating a report text message based on the result information;
communicating the report text message via the one or more communication networks to the wireless communication device from which the command text message was transmitted; and
displaying the report text message at the wireless communication device.

In another aspect, the invention provides a service provider computer system for processing information contained in text messages. The computer system of this embodiment includes a processor connected to a communication interface. The communication interface receives a command text message that was transmitted from a wireless communication device and communicated via a wireless communication network. The processor extracts identification information and function information from the command text message, where the identification information identifies a wireless asset monitoring device and the function information indicates a function to be performed by the wireless asset monitoring device. The processor generates a command in a communication format that is compatible for transmission to the wireless asset monitoring device, where the command includes at least the identification information for the wireless asset monitoring device and the function information for indicating the function to be performed by the wireless asset monitoring device. The communication interface sends the command to be transmitted to the wireless asset monitoring device via the wireless communication network. In some situations, the communication interface also receives a response transmitted from the wireless asset monitoring device via the wireless communication network. The processor extracts result information from the response and generates a report text message based on the result information. The report text message includes identification information for identifying the wireless asset monitoring device that transmitted the response and the result information indicating the result of the function performed by the wireless asset monitoring device. The communication interface sends the report text message to be transmitted to the wireless communication device via the wireless communication network.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 depicts a functional block diagram of a communication and monitoring system according to a preferred embodiment of the invention; and

FIG. 2 depicts a method for communicating text messages between a mobile wireless communication device and a wireless asset monitoring device according to a preferred embodiment of the invention.

### DETAILED DESCRIPTION

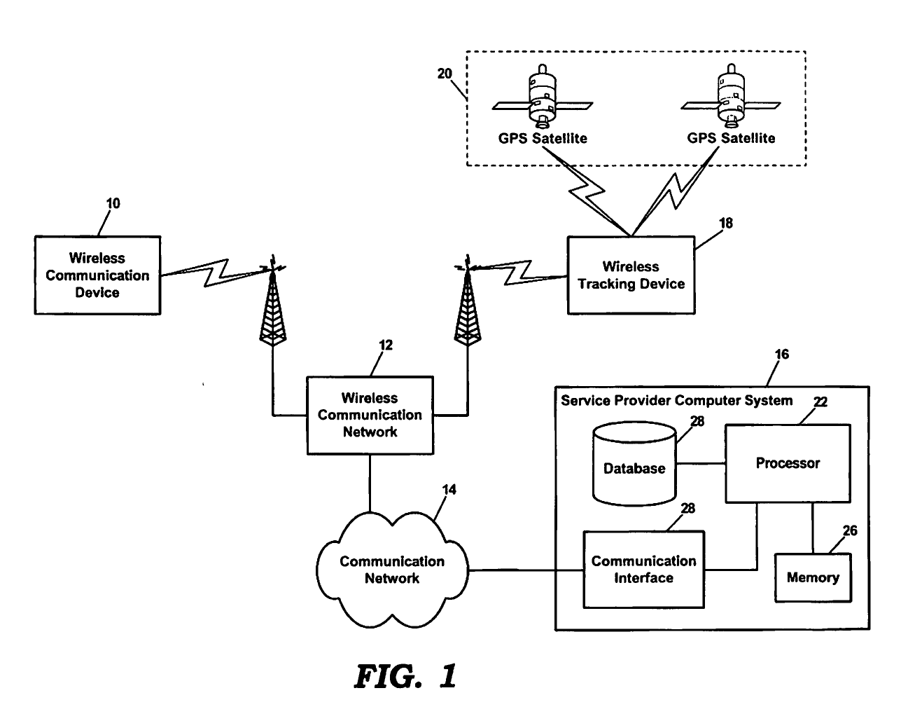

As shown in FIG. 1, a preferred embodiment of a tracking, monitoring and communication system includes a mobile wireless communication device 10, such as a handheld cellular phone, a Personal Digital Assistant (PDA) or other portable personal device having wireless communication capabilities. The mobile wireless communication device 10 may operate according to any one of several communication protocols, including Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA), and Integrated Digital Enhanced Network (iDEN).

The mobile wireless communication device 10 communicates with a wireless communication network 12, such as a cellular telephone network, which may operate using any one or more of the communication protocols listed above, or other communication protocol. The wireless communication network 12 is connected to a communication network 14, which may be a virtual private network (VPN) or a global network, such as the Internet.

A service provider computer system 16 is also connected to the communication network 14. In preferred embodiments of the invention, the service provider computer system 16 is associated with a subscription-based asset tracking and monitoring service, such as described in U.S. Pat. No. 7,102,510. The service provider computer system 16 includes a processor 22, a network communication interface 24, memory 26 and a database 28. The database 28 provides for storing serial numbers of asset monitoring devices, user PIN/passwords and other customer account information. The communication interface 24 provides for transferring data between the computer system 16 and the communication networks 12 and 14. As described in more detail hereinafter, the processor 22 executes software modules for validating serial numbers and PINs/passwords, for processing command messages and response messages, for generating report messages to be transmitted to the user's wireless communication device, and for processing geographical information based on location coordinates reported from asset monitoring devices.

With continued reference to FIG. 1, the system 10 includes a wireless asset monitoring device 18 attached to a mobile asset, such as an automobile, boat, motorcycle, aircraft, shipping container, transfer truck/trailer, animal, pet or person. Preferably, the monitoring device 18 is a self-contained portable device that is collocated with the mobile asset. The monitoring device 18 preferably includes a Global Positioning System (GPS) receiver, a processor, memory, and a wireless transceiver. In one embodiment, the monitoring device 18 is powered by the power system in the vehicle or other asset in which it is located. The components of the monitoring device 18 may be contained within a portable housing having a power cord and plug compatible with a standard 12 volt power receptacle in a vehicle such as an automobile or boat. In another embodiment, the monitoring device 18 is semi-permanently installed in the engine compartment, dashboard or console of an automobile, boat or other mobile asset. One example of the monitoring unit 18 is the SAT TRAK™ ES-030 device manufactured by PROCON, Inc. of Knoxville, Tenn.

The GPS receiver of the monitoring device 18 receives signals transmitted from a constellation of GPS satellites 20 in earth orbit. Based on these signals, the GPS receiver determines coordinates of the location of the mobile asset in which the monitoring device 18 is installed. Preferably, these coordinates are expressed in longitude and latitude format. However, it should be appreciated that the invention is not limited to operation in any particular coordinate system. In a preferred embodiment, the processor of the monitoring device 18 accesses the location coordinates from the GPS receiver and formats the coordinates for transmission over the wireless communication network 12.

In one embodiment, the processor formats the coordinates as a string of characters suitable for transmission in a digital cellular format. Besides the location information, the string may also include an identification number associated with the monitoring device 18 and a timestamp indicating the time at which the location coordinates were determined. Preferably, the location coordinates and timestamp are stored in the memory of the monitoring device 18, so that location information may be recalled from memory and transmitted at any later time. The location information is provided to the transceiver of the wireless monitoring device 18 for transmission over the wireless communication network 12, preferably according to a standard wireless communication protocol.

Besides determining location information, the wireless monitoring device 18 performs functions for controlling certain operations of the mobile asset in which it is installed. For example, in an embodiment installed in an automobile, the wireless monitoring device 18 is connected to the starter of the automobile and is operable to disable or enable the starter. The wireless monitoring device 18 may also be operable to unlock the doors of the vehicle in which it is installed.

In some embodiments, the wireless monitoring device 18 is interfaced to a vehicle's computer system through an on-board diagnostics (OBD) connector. Through this connection, the wireless monitoring device 18 can access vehicle diagnostic information and provide commands to the vehicle computer.

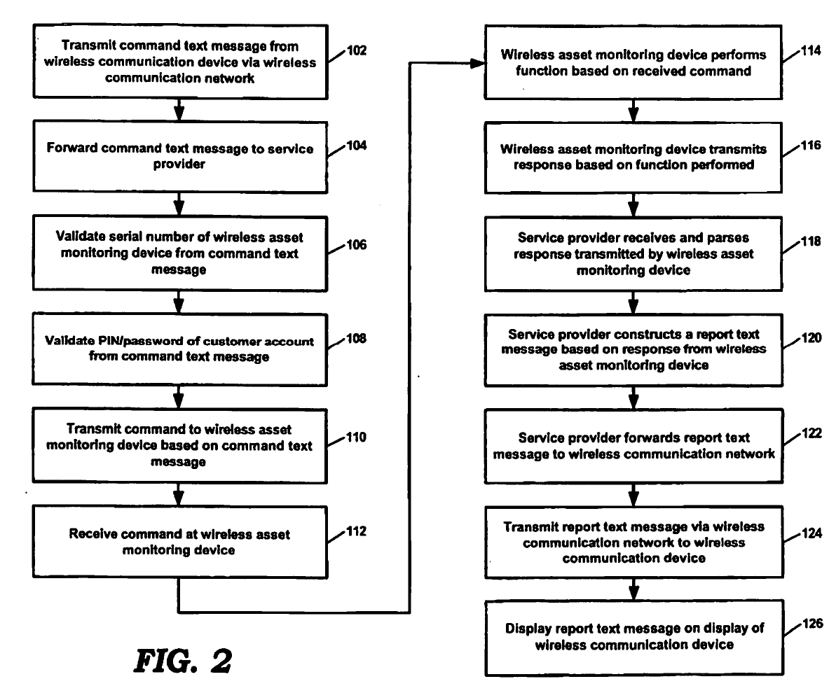

Shown in FIG. 2 is one embodiment of a method for communicating between the wireless communication device 10 and the wireless asset monitoring device 18 using a text messaging protocol, such as SMS. To begin a communication session, a user of the wireless communication device 10 enters a text message, such as in the following format, which is transmitted via the wireless communication network 12 (step 102):
To: <ShortCode>
Msg: <Serial><b><PIN/Password><b><Command>
   where:
<ShortCode>=four (4) or five (5) digit code corresponding to the Common Short Code (CSC) of the service provider 16;
<Serial>=serial number of the wireless monitoring device 18;
<b>=a space or “blank” character;
<PIN/Password>=four (4)-digit Personal Identification Number (PIN) or case-sensitive Password assigned to the user's account to which the serial number of the wireless monitoring device 18 has been registered; and
<Command>=a Location Based Services (LBS) command that will be transmitted to the wireless monitoring device 18. In one embodiment of the invention, <Command> can have the following values:
   “1” (one), “1” (lower-case L) or “L” (upper-case L)=LOCATE the monitoring device 18;
   “2” (two), “d” (lower-case D) or “D” (upper-case D)=DISABLE STARTER of the automobile or asset in which the monitoring device 18 is installed;
   “3” (three), “e” (lower-case E) or “E” (upper-case E)=ENABLE STARTER of the automobile or asset in which the monitoring device 18 is installed; and
   “9” (nine), “u” (lower-case U) or “U” (upper-case U)=UNLOCK the doors of the automobile or asset in which the monitoring device 18 is installed.

The text message in the above format, which is referred to herein as a command text message, is communicated through the wireless communication network 12 and the communication network 14 to the service provider computer system 16 (step 104). In a preferred embodiment, the service provider computer system 16 receives the command text message transmitted from the wireless communication device 10 and validates that the serial number is in a valid serial number format and properly registered to a customer of the service provider (step 106) as indicated by records stored in the database 28. User authentication by the service provider computer system 16 may be performed to address any possible user privacy issues. Although the user does not necessarily have to be the user to which the serial number of the wireless monitoring device 18 has been registered, once the user is authenticated, the user is deemed to be authorized to use the service.

If the serial number is not in the expected format or is not properly registered to a customer, then a report text message is returned to the wireless communication device 10 (via the communication networks 12 and 14) in the following format:

trakSMS™—Serial number <Serial> is not valid.

In this case, the communication session is deemed complete but unsuccessful.

If the serial number is valid, the service provider computer system 16 authenticates the submitted PIN/Password against the customer's account to which the serial number of the monitoring device 18 has been registered (step 108). If the PIN/Password cannot be authenticated to the customer's account, then the following report text message is returned to the wireless communication device 10 (via the communication networks 12 and 14):
trakSMS™—PIN/Password =<PIN/Password> could not be authenticated for Serial Number <Serial>.
   In this situation, the transaction is deemed complete but unsuccessful.

Once the serial number has been validated and the PIN/Password authenticated, the service provider computer system 16 sends the LBS command to the monitoring device 18 identified by the serial number <Serial> (step 110). In one embodiment, the LBS command is sent to the monitoring device 18 via the service provider computer system 16.

The wireless monitoring device 18 receives the LBS command and processes the command to determine what function is to be performed. The wireless asset monitoring device 18 then performs the function, such as determining and transmitting location information, disabling/enabling the starter or unlocking the doors (step 114). The monitoring device 18 also transmits a response based on the function performed (step 116).

The service provider computer system 16 continuously looks for the response transmitted from the monitoring device 18. Once a response is received, the service provider computer system 16 parses and interprets the response (step 118) and constructs a report text message to be sent to the wireless communication device 10 (step 120). The report text message is forwarded via the communication network 14 to the wireless network 12 (step 122) and is transmitted via the wireless network 12 to the wireless communication device 10 (step 124).

If the monitoring device 18 has responded properly, the wireless communication device 10 will receive a report text message in the following format which is displayed on the display screen of the wireless communication device 10 (step 126):
trakSMS™—<Response> for Serial <Serial> on <Time>—Nearest Address: <NearestAddress>—Speed: <Speed>—Direction: <Direction>
   where:
<Response> corresponds to the <Command> submitted as described above and may have the following values:
   Location;
   Starter Disabled;
   Starter Enabled; and
   Unlock
<Serial>=the serial number of the monitoring device 18 as entered by the user;
<Time>=the time at which the LBS command was completed (adjusted to the time zone corresponding the <Nearest Address>). Otherwise time is provided in UTC (Universal Time) format;
<Nearest Address>=the address of the monitoring device 18. The Nearest Address may be “Reverse Geocoded” from the GPS coordinates (Latitude and Longitude) provided by the monitoring device 18 (when available);
<Speed>=the speed provided by the monitoring device 18 (when available) in MPH (miles per hour) or KPH (kilometers per hour); and
<Direction>=the geographical direction provided by the monitoring device 18 (when available) in a two-letter code (ie., NW=North-West).

If the monitoring device 18 has responded with an improper response, or the service provider computer system 16 did not receive a proper response from the monitoring device 18, the wireless communication device 10 will receive a report text message in the following format which is displayed on the display screen of the wireless communication device 10 (step 126):
trakSMS™—Serial number <Serial> could not be <Action>. Exception: <Exception> Please try later!
   where:
<Serial>=serial number of the monitoring device 18 as submitted by the user.
<Action> corresponds to the <Command> submitted as described above and may have the following values:
   Located;
   Starter Disabled;
   Starter Enabled; and
   Unlocked;
<Exception>=description of exception (time-out, device not responding, etc.)

Other functions/actions that may be provided via text messaging are listed below in Table I.

TABLE I

| Command | Description |
|---|---|
| AUTOREPORT_ON/OFF | Enable/Disable automatic and |
| | periodic reporting by the device |
| BATTERYLEVEL_SET | Set the battery power level for |
| | devices equipped with a battery |
| | backup |
| FIRMWARE_UPDATE | Update the firmware of the device |
| DRIVEREPORT_ON/OFF | Enable/Disable automatic reporting |
| | every time a vehicle (with an |
| | installed device) starts a trip |
| GEOFENCE_LOCAL_ON/OFF | Set a geofence with its center |
| | point at the device's current |
| | location. Alerts are reported |
| | whenever a device enters and/or |
| | exits the defined geofence |
| GEOFENCE_SET | Set a geofence (one of several that |
| | can be set) around a specific |
| | geographical location. |
| LOCATE | Transmit location coordinates of |
| | device |
| MAXSPEED_SET | Set a maximum speed limit. Alerts |
| | are reported whenever the devices |
| | exceeds the maximum speed limit set. |
| PANIC_SET | Hidden device panic button has been |
| | triggered |
| REMOTE_START | Start vehicle engine remotely |
| STARTER_ENABLE/DISABLE | Enable/disable vehicle staffer |
| UNLOCK_DOORS | Unlock vehicle doors |
| WARNING_ON/OFF | Turn on/off audible reminder when- |
| | ever the vehicle's ignition is |
| | turned on (may be used as “Payment |
| | Overdue“ reminder) |

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated.

1. A method for communicating information between a portable wireless communication device and a wireless asset monitoring device, comprising:
(a) transmitting a command text message from the wireless communication device, wherein the command text message includes at least identification information that identifies the wireless asset monitoring device and function information that indicates one or more functions to be performed by the wireless asset monitoring device;
(b) communicating at least the identification information and the function information via one or more communication networks to a service provider computer system associated with a service provider;
(c) transmitting a command from the service provider computer system, the command including at least the identification information and the function information;
(d) receiving the command at the wireless asset monitoring device identified by the identification information; and
(e) executing the one or more functions at the wireless asset monitoring device as indicated by the function information.

2. The method of claim 1 further comprising:
(f) transmitting a response from the wireless asset monitoring device, wherein the response includes at least identification information for identifying the wireless asset monitoring device which transmitted the response and result information for indicating a result of the function executed by the wireless asset monitoring device;
(g) receiving the response at the service provider computer system and extracting the identification information and the result information;
(h) generating a report text message based on the result information;
(i) communicating the report text message via the one or more communication networks to the wireless communication device from which the command text message was transmitted; and
(j) displaying the report text message at the wireless communication device.

3. The method of claim 1 wherein the command text message includes function information for indicating a function selected from the group consisting of
reporting a location of the wireless asset monitoring device,
enabling/disabling a starter of a vehicle in which the wireless asset monitoring device is installed,
unlocking doors of a vehicle in which the wireless asset monitoring device is installed,
reporting motion of a vehicle in which the wireless asset monitoring device is installed,
reporting disconnection of a vehicle battery of a vehicle in which the wireless asset monitoring device is installed,
reporting when a vehicle in which the wireless asset monitoring device is installed has exceeded a speed threshold,
reporting when a vehicle in which the wireless asset monitoring device is installed has traveled beyond a geographical boundary,
enabling/disabling automatic and periodic reporting by the wireless asset monitoring device,
setting a battery power level for the wireless asset monitoring device,
remotely starting an engine of a vehicle in which the wireless asset monitoring device is installed, and
enabling/disabling an audible reminder that a loan payment is overdue whenever an ignition is turned on in a vehicle in which the wireless asset monitoring device is installed.

4. The method of claim 1 wherein the command text message of step (a) includes personal identification number information for a subscriber account established with the service provider.

5. The method of claim 1 wherein step (a) comprises transmitting the command text message in a Short Message Service (SMS) format.

6. The method of claim 1 wherein step (i) comprises communicating the report text message in a Short Message Service (SMS) format.

7. The method of claim 2 wherein the report text message includes an indication of the function performed at the wireless asset monitoring device, the identification information associated with the wireless asset monitoring device, and the time at which the function was performed.

8. The method of claim 2 wherein:
step (a) comprises transmitting a command text message which includes function information for indicating a function of reporting the location of the wireless asset monitoring device; and
step (i) comprises communicating the report text message which includes information indicating the location of the wireless asset monitoring device.

9. A service provider computer system for processing information contained in text messages, the computer system comprising:
a communication interface for receiving a command text message transmitted from a wireless communication device and communicated via a wireless communication network;
a processor connected to the communication interface, the processor for extracting at least identification information and function information from the command text message, wherein the identification information identifies a wireless asset monitoring device and the function information indicates a function to be performed by the wireless asset monitoring device;
the processor for generating a command in a communication format compatible for transmission to the wireless asset monitoring device, the command including at least the identification information for the wireless asset monitoring device and the function information for indicating the function to be performed by the wireless asset monitoring device;
the communication interface for sending the command to be transmitted to the wireless asset monitoring device via the wireless communication network;
the communication interface for receiving a response transmitted from the wireless asset monitoring device via the wireless communication network;
the processor for extracting result information from the response and generating a report text message based on the result information, the report text message including at least identification information for identifying the wireless asset monitoring device that transmitted the response and the result information indicating a result of the function performed by the wireless asset monitoring device; and
the communication interface for sending the report text message to be transmitted to the wireless communication device via the wireless communication network.

10. The apparatus of claim 9 wherein the command text message includes function information for indicating a function selected from the group consisting of
reporting a location of the wireless asset monitoring device,
disabling a starter of a vehicle in which the wireless asset monitoring device is installed,
enabling a starter of a vehicle in which the wireless asset monitoring device is installed,
unlocking doors of a vehicle in which the wireless asset monitoring device is installed,
reporting motion of a vehicle in which the wireless asset monitoring device is installed,
reporting disconnection of a vehicle battery of a vehicle in which the wireless asset monitoring device is installed,
reporting when a vehicle in which the wireless asset monitoring device is installed has exceeded a speed threshold, and
reporting when a vehicle in which the wireless asset monitoring device is installed has traveled beyond a geographical boundary.

11. The apparatus of claim 9 wherein the command text message and the report text message are in a Short Message Service (SMS) format.

12. The apparatus of claim 9 wherein the report text message includes an indication of the function performed at the wireless asset monitoring device, the identification information associated with the wireless asset monitoring device, and the time at which the function was performed.

13. The apparatus of claim 9 wherein the command text message includes function information for indicating a function of reporting the location of the wireless asset monitoring device, and the report text message includes information indicating the location of the wireless asset monitoring device.

14. An apparatus for communicating information between a portable wireless communication device and a wireless asset monitoring device, the apparatus comprising:
means for transmitting a command text message from the wireless communication device, wherein the command text message includes at least identification information that identifies the wireless asset monitoring device and function information that indicates one or more functions to be performed by the wireless asset monitoring device;
means for communicating at least the identification information and the function information via one or more communication networks to a service provider computer system associated with a service provider;
means for transmitting a command from the service provider computer system, the command including at least the identification information and the function information;
means for receiving the command at the wireless asset monitoring device identified by the identification information; and
means for executing the one or more functions at the wireless asset monitoring device as indicated by the function information.

15. The apparatus of claim 14 further comprising:
means for transmitting a response from the wireless asset monitoring device, wherein the response includes at least identification information for identifying the wireless asset monitoring device which transmitted the response and result information for indicating a result of the function executed by the wireless asset monitoring device;
means for receiving the response at the service provider computer system and extracting the identification information and the result information;
means for generating a report text message based on the result information;
means for communicating the report text message via the one or more communication networks to the wireless communication device from which the command text message was transmitted; and
means for displaying the report text message at the wireless communication device.
